(19) United States
(12) Patent Application Publication
(10) Pub. No.: US 2018/0329468 A1
(43) Pub. Date: Nov. 15, 2018

(54) SELECTION OF A DATA LOSS PREVENTION TECHNIQUE

(71) Applicant: HEWLETT PACKARD ENTERPRISE DEVELOPMENT LP, Houston, TX (US)

(72) Inventors: Lee Nelson, Boise, ID (US); Siamak Nazari, Mountain View, CA (US)

(21) Appl. No.: 15/771,582

(22) PCT Filed: Apr. 29, 2016
(86) PCT No.: PCT/US2016/030060

§ 371 Date: Apr. 27, 2018

(51) Int. Cl. G06F 1/30; G06F 1/28; G06F 11/14; G06F 11/20

(52) U.S. Cl. CPC G06F 1/30; G06F 11/2015; G06F 11/1402; G06F 1/28

(57) ABSTRACT

Examples herein disclose an identification of a backup power structure, among various backup power structures, implemented in a storage system. In response to the identification of the backup power structure, the examples select a data loss prevention technique to implement in storing write data to the storage system. The data loss prevention technique is selected among various loss prevention techniques corresponding to the various backup power structures.

### BACKGROUND

Block-level storage is a type of storage system which may be deployed by larger enterprises in storage area networks (SANs) and other similar large-scale storage systems. Each block in the block-level storage system may be controlled as an individual hard drive, and the blocks are managed by a server operating system. In the block-level storage system, storage devices such as a dual in-line memory module (DIMM) and persistent memory may be utilized to store data from a server.

### BRIEF DESCRIPTION OF THE DRAWINGS

In the accompanying drawings, like numerals refer to like components or blocks. The following detailed description references the drawings, wherein:

FIG. 1 illustrates an example storage system including a storage controller to select a data loss prevention technique based on an identified backup power structure in accordance with the present disclosure;

FIG. 2 illustrates an example storage system including various backup power structures in accordance with the present disclosure;

FIG. 3 is a flowchart of an example method to select a data loss prevention technique based on an identified backup power structure implemented in a storage system in accordance with the present disclosure;

FIG. 4 is a flowchart of an example method to employ a selected data loss prevention technique for storing write data at a memory component coupled to an identified backup power structure in accordance with the present disclosure;

FIG. 5 is a flowchart of an example method to employ various selected data loss prevention techniques depending on a type of backup power structure is implemented in the storage system in accordance with the present disclosure;

FIG. 6 is a block diagram of an example computing device with a processing resource to execute instructions in a machine-readable storage medium for implementing a data loss prevention technique in a storage system in accordance with the present disclosure; and

FIG. 7 is a block diagram of an example computing device with a processing resource to execute instructions in a machine-readable storage medium for implement various loss prevention techniques depending on a type of backup power structure that is identified in a storage system in accordance with the present disclosure.

### DETAILED DESCRIPTION

A block storage system may include a persistent storage memory to maintain data, even if power to the storage system may be lost or removed. To improve performance, the storage system may include a write cache in a DIMM to temporarily store write data that has not yet been written to the persistent memory. The storage system may send an acknowledgement of the write request after write data has been stored to the write cache, but prior to storing in the persistent memory. The write cache may include a volatile memory that can lose the write data if power is lost prior to storing in the persistent memory. This may result in an inconsistent data condition as the acknowledgement may be sent prior to successful completion of the write data to the persistent memory.

To address the lost data issue, backup power structures may be implemented in the storage system. The structures may include a backup power source (e.g., battery) coupled to memory components within the storage system to provide temporary power for a period of time. Providing the backup power source preserves the content of the write cache in the event of a power outage. For example, a first power backup structure may provide power to a memory, but not to other components (such as a controller) in the system. The first power backup structure may be used to temporarily provide power to the volatile memory to prevent data loss. In another example, a second power backup structure may include a larger backup power source to supply power to a larger number of components, such as the memory components and the controller. Although two example backup power structures are described, it is noted there may be more than two different backup power structures.

Depending on which backup power structure is implemented in the storage system, different data loss prevention techniques may be used. Data loss prevention technique may refer to an approach to prevent data loss in the write cache in the event of the power outage. A developer may provide code to employ one of the data loss prevention techniques; however, it may be undesirable to provide different storage system codes depending on which backup power structure is used. For example, writing and maintaining different storage system codes for different backup power structures may increase manufacturing costs and complexity. When referring to “code,” implementations are limited to storage system code that may refer to machine-readable instructions that manage various operations of a storage system. The various operations of the storage system may include saving data to a persistent memory, storing data in a write cache, exchanging communications, recovering from a power outage, etc.

The present disclosure provides a mechanism to efficiently prevent data loss from the write cache due to a power outage. The disclosure provides a storage controller which utilizes a storage system code capable of accommodating each of the backup power structure approaches. The storage controller detects which backup power structure is used within the storage system. Based on the detected backup power structure, the storage controller employs the appropriate data loss prevention technique. Through employing the appropriate data loss prevention technique, the storage controller may change strategy based on the backup power structure implemented in the storage system. Additionally by changing strategy, the storage system may be capable of supporting various types of backup power structures.

In response to the detected backup power structure, the storage controller may proceed to dynamically select which data loss prevention technique to employ. By dynamically selecting which data loss prevention technique to employ, the storage controller may proactively respond to prevent data loss. Additionally through the selection of which power loss technique to employ, the storage controller provides a layout of which components to write data to maintain the data content.

The following detailed description refers to the accompanied figures. Wherever possible, the same reference numbers are used in the figures and the following description to refer to the same or similar parts. It is to be expressly understood, however, that the figures are for the purpose of illustration and description only. While several examples are described throughout, modification, adaptions, and other implementations are possible. Accordingly, the following detailed description is not meant to limit the disclosed examples, rather it is meant to provide proper scope of the disclosed examples and may be defined by the appended claims.

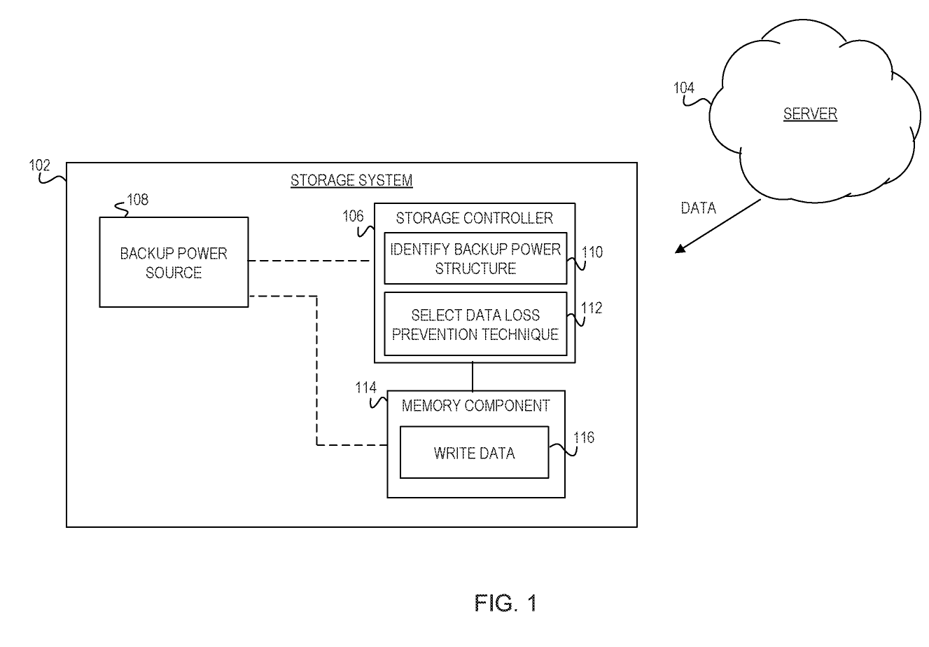

FIG. 1 is a block diagram of an example storage system 102 including storage controller 106, backup power 108, and memory component 114. Storage controller 106 identifies a backup power structure that is implemented in storage system 102 at module 110. The identified backup power structure represents an arrangement of components that is to receive power from backup power source 108 in an event of a power outage. In response to identification of the backup power structure, storage controller 106 proceeds to select a data loss prevention technique at module 112. The data loss prevention technique may be selected among various data loss prevention techniques. Each of the various data loss prevention techniques correspond to each of the backup power structures which may be implemented in storage system 102. Based on selection of the data loss prevention technique, storage controller 106 may receive data from server 104 for writing data in memory component 114 at module 116. Storage system 102 operates in conjunction with server 104 to provide components and recording media used to retain digital data. As such, implementations of storage system 102 include, by way of example, a disk array system, hard drive system, non-volatile memory system, cartridge system, magnetic storage system, optical storage system, or other type of storage system capable of working in conjunction with server 104 to retain data. Additionally, although FIG. 1 illustrates storage system 102 as including single memory component 114, this was done for illustration purposes and not to limit the present disclosure. For example, FIG. 1 may further include additional memory components.

Server 104, operates in conjunction with storage system 102 to manage access to data. As such, server 104 communicates with storage system 102 to store and write data in memory component(s) 114. Server 104 may include a communication channel to storage system 102 to provide this storage functionality. Implementations of server 104 include, by way of example, a database server, mail server, file server, domain name system (DNS) server, print server, web server, game server, application server, host server, cartridge server, blade server, catalog server, communication server, home server, media server, proxy server, or other type of computing device(s) capable of operating in conjunction with storage system 102 to perform and store write data. Although FIG. 1 illustrates storage system 102 and server 104 as remote from one another, this was done for illustration purposes as storage system 102 may be implemented as part of server 104.

Storage controller 106 identifies backup power structure implemented in storage system 102 and in turn selects the data loss prevention technique at modules 110-112. Storage controller 106 provides management of storage system 102 such that data is received by server 104 and written into various memory component(s) 114. As such, storage controller 106 has a direct I/O path to memory component 114. The I/O path communicates to memory component 114 for handling a movement of data as well as other data-related functions such as redundant array of independent disks (RAID) and volume management. Implementations of storage controller include, by way of example, a virtualized controller, software-defined networking (SDN) controller, a networking device, interface controller, processing device, an application-specific integrated circuit (ASIC), central processing unit (CPU), integrated circuit, semiconductor, processing resource, or other type of hardware component capable of the functionality of storage controller 106.

Backup power source 108 is a power supply which may provide power to memory component 114 and/or storage controller 106 during the event of a power outage of storage system 102. By supplying power to at least memory component 114, data may be maintained in the memory component 114 for a period of time. In an implementation, backup power source 108 may be carried out by a battery or other type of capacitive power source to deliver power to the arrangement of components. The various backup power source structures each represent a different arrangement or combination of components in storage system 102. For example, one of the backup power structures delivers power to memory component 114 and storage controller 106 while another backup power structure delivers power only to memory component 114. As such, each of the various backup power structures correspond to a different data loss prevention technique. In this example, each data loss prevention technique depends on which backup power source structure is implemented in storage system 102. A dotted line between backup power source 108 and memory component 114 is illustrated to depict the various arrangements backup power source 108 may provide to storage system 102. For example, backup power source 108 may provide power exclusively to memory component 114 or may provide power to memory component 114, storage controller 106, and additional components (not illustrated). This implementation may be discussed in detail in a later figure.

At modules 110-112, storage controller 106 identifies which backup power structure is implemented storage system 102 and in turn selects the data loss technique. Responsive to determining which of the various backup power structures is implemented in storage system 102, storage controller 106 includes code that may dynamically select from among different data loss prevention techniques. When referring to “code,” implementations are limited to storage system code that may refer to machine-readable instructions that manage various operations of storage system 102. The various operations of storage system 102 include saving data to a persistent memory, storing data in a write cache, exchanging communications, recovering from a power outage in storage system 102, etc. In this manner, storage controller 106 dynamically selects which data loss technique corresponds to the identified backup power structure. Modules 110-112 may include, by way of example, instructions (e.g., stored on a machine-readable medium) that, when executed (e.g., by storage controller 106), implements the functionality of modules 110-112. Alternatively, or in addition, modules 110-112 may include electronic circuitry (i.e., hardware) that implements the functionality of modules 110-112.

Memory component 114 is a storage area within storage system 102 capable to store and retain data from server 104. Memory component 114 may be coupled to the identified backup power structure. This means backup power source 108 is connected to memory component 114 such that upon an event of a power outage in storage system 102, backup power source 108 may provide power to memory component 114. In an implementation, memory component 114 may operate to store a bit of data in a separate capacitor within storage system 102. In this implementation, the capacitor may discharge, thus the two states of charge or discharge represent the two values of a bit (e.g., 0 or 1). In further implementation based on data being written to memory component 114 from server 104, storage controller 106 may operate to transfer the data from memory component 114 to more permanent storage, such as a persistent memory. In another implementation memory component 114 may include a dual in-line memory module (DIMM). In this implementation, the DIMM is a module containing at least one random access memory (RAM) chip with soldering joints in which to electrically connect the DIMM to a board containing storage controller 106. Implementations of memory component 114 include the DIMM, storage disk, hard disk, disk array, hard drive, volatile memory, non-volatile memory, persistent memory, semiconductor memory, read-only memory, dynamic random-access memory (DRAM), etc.

At module 116 storage controller 106 implements the selected data loss technique for storing write data at memory component 114 coupled to backup power source 108. FIG. 1 illustrates one example of a possible data loss prevention technique based on the type of backup power structure which is implemented in storage system 102. Other examples of data loss prevention techniques may include storing user data in one coupled memory component (e.g., DIMM) while storing metadata in a different coupled memory component. Yet a further example includes storing write operations in an uncoupled memory component. The examples may be discussed in detail in later figures. Module 116 may include, by way of example, instructions (e.g., stored on a machine-readable medium) that, when executed (e.g., by storage controller 106), implements the functionality of module 116. Alternatively, or in addition, module 116 may include electronic circuitry (i.e., hardware) that implements the functionality of module 116.

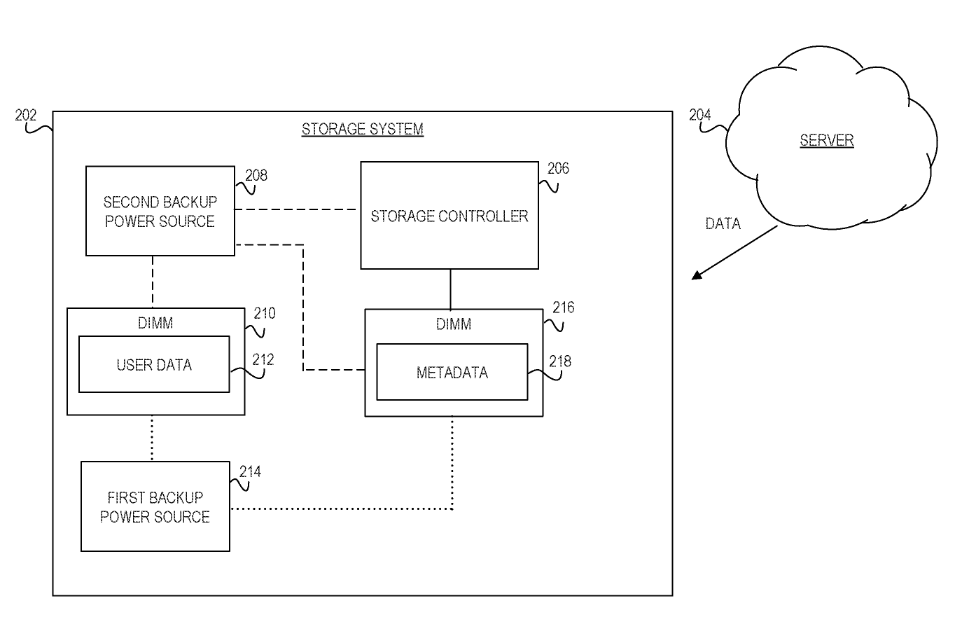

FIG. 2 illustrates an example storage system 202 including various backup power structures. The various backup power structures may include different arrangements of providing power to combinations of components within storage system 202. As such, the different types of backup power structures may include a first backup power structure and a second power structure. The first backup power structure includes first backup power source 214 to provide power to DIMM 210 and/or DIMM 216, but not storage controller 206. For example, first backup power source 214 is coupled to DIMM 210 and/or DIMM 216 to provide power to these components 210 and/or 216 in the event of a power outage. The second backup power structure includes second backup power source 208 to provide power to storage controller 206 in addition to DIMM 210 and/or DIMM 216. For example, second backup power source 208 is coupled to storage controller 206 and at least one of DIMMs 210 and 216 to provide power to these components 206, 210, and/or 216 in the event of the power outage to storage system 202.

Storage controller 206 identifies which backup power structure is implemented in storage system 202 and in turn selects a data loss prevention technique among various data loss prevention techniques. Each data loss prevention technique corresponds to one of the backup power structures, such that each data loss prevention technique depends on the type of backup power structure used in storage system 202.

For example in response to the implementation of the first backup power structure (e.g., first backup power source 214 coupled to DIMMs 210 and/or 216 but not storage controller 206), storage controller 206 dynamically selects the data loss prevention technique. The data loss prevention technique corresponding to first backup power structure includes storing user data in DIMM 210 while storing metadata 218 in DIMM 216. The first backup power structure, may also be referred to as the use of power backed DIMM. In this case, first backup power source 214 may be smaller in size since it provides emergency power to DIMMs 210 and/or 216. During the emergency situation of the power outage, first backup power source 214 provides power to DIMMs 210 and/or 216 to maintain user data 212 and metadata 218. This ensures the contents (user data 212 and metadata 218) are not loss during the power outage. Upon restoring power to storage system 202, the user data and metadata held in the write caches of DIMMs 210 and 216 may be moved to a persistent memory (not illustrated). Although FIG. 2 illustrates the data loss prevention technique as storing user data and metadata in two different DIMMs 210 and 216, this was done for illustration purposes. For example, if first backup power structure is coupled to only one DIMM 210 or 216, then the user data and metadata may be stored together on the one coupled DIMM 210 or 216.

In another example, in response to the implementation of the second backup power structure (e.g., second backup power source 208 coupled to storage controller 206 and DIMMs 210 and/or 216), storage controller 206 dynamically selects the data loss prevention technique. The data loss prevention technique corresponding to second backup power structure includes moving data (e.g., user data 212 and metadata 218) from DIMMs 210 and 216 into a persistent memory (not illustrated) . In this case, while using second backup power source 208, the write cache and metadata held in DIMM memory are transferred to persistent media, such as solid state disk (SSD) and/or spinning media integrated drive electronics (IDE).

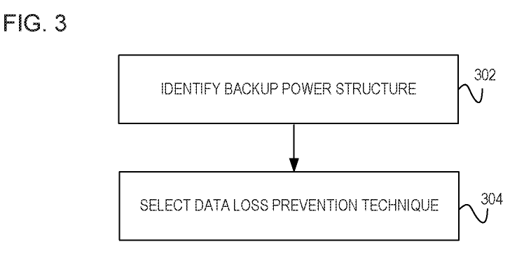

Referring now to FIGS. 3-5, example flowcharts are illustrated in accordance with various examples of the present disclosure. The flowcharts represent processes that may be utilized in conjunction with various systems and devices as discussed with reference to the preceding figures. While illustrated in a particular order, the flowcharts are not intended to be so limited. Rather, it is expressly contemplated that various processes may occur in different orders and/or simultaneously with other processes than those illustrated.

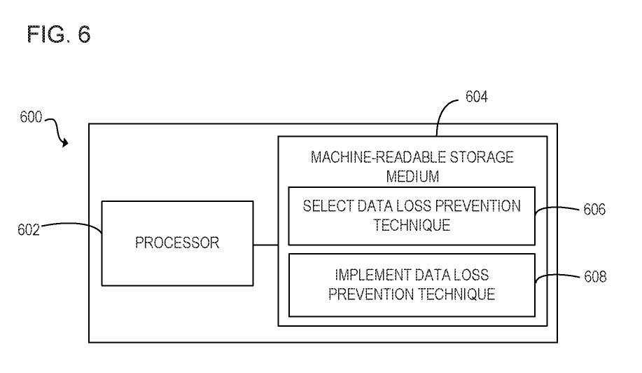

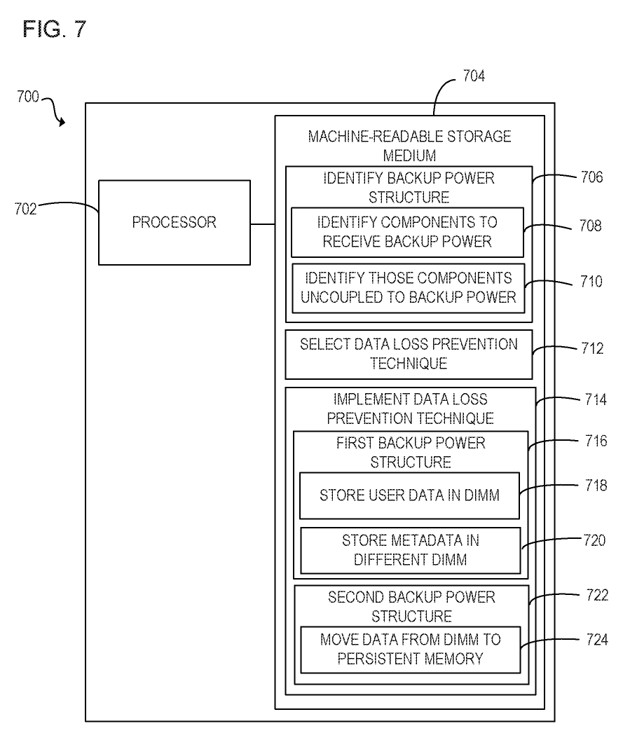

FIG. 3 is a flowchart of an example method, executable by a storage controller, to select a data loss prevention technique based on an identified backup power structure. The storage controller identifies which backup power structure is implemented in a storage system. The backup power structure may be identified among various backup power structures in which the storage system is capable of supporting. Upon identifying the specific backup power structure implemented in the storage system, the storage controller proceeds to select the data loss prevention technique. The data loss prevention technique is selected among various data loss prevention techniques. Each of the various data loss prevention techniques correspond to a different backup power structure. The selected data loss prevention technique is the technique for implementation in storing write data in the storage system. In discussing FIG. 3, references may be made to the components in FIGS. 1-2 to provide contextual examples. In one implementation, storage controller 106 as in FIG. 1 executes operations 302-304 to select the data loss prevention technique. Further, although FIG. 3 is described as implemented by the storage controller, it may be executed on other suitable components. For example, FIG. 3 may be implemented in the form of executable instructions on a machine-readable storage medium 604 and 704 as in FIGS. 6-7. In other implementations, the illustrated flowchart may be executed by a computing device.

At operation 302 the storage controller identifies the specific backup power structure implemented in the storage system. The specific backup power structure may be identified from various backup power structures. Each of the various backup power structures provide power to a different combination or arrangement of components in the storage system. For example, a first backup power structure may provide power to memory components and the storage controller in the event of a power outage while a second backup power structure may only provide power to a limited number of memory components (e.g., DIMMs). In this implementation, the storage controller identifies which components are coupled to the identified backup power structure and which components are uncoupled (i.e., not coupled) to the identified backup power structure. The components that are coupled to the backup power structure are those components which would receive power from the backup source in the situation of the storage system experiencing a power outage. This implementation enables the storage controller to determine what components are power source backed components from those components which do not coupled to the backup power source. Using those components that may receive power from the backup power source in the case of the power outage, ensures those components do not lose data during the power outage. This prioritizes those components coupled to the backup power source to store data which may not survive the power cycle. In another implementation, the components are identified from a table which lists the type of backup power structure and the corresponding components that may be coupled to the backup power source.

At operation 304 in response to the identification of the backup power structure, the storage controller selects the data loss prevention technique. The data loss prevention technique may be selected from various loss prevention techniques. Each data loss prevention technique corresponds to a different backup power structure. This means the technique employed by the storage controller is dependent on the type of backup power structure. The data loss prevention technique is a way in which to prevent data loss in the event of a power outage is carried out. As such, the data loss prevention technique is a mechanism in which to implement in storing write data in the storage system. The way the data loss prevention technique is carried out may depend on the type of backup power structure. For example, some memory components in the storage system may be connected to a battery source in case of the power outage, while other memory components may remain unconnected to the battery source. As such, precautions may be taken to ensure the data at the unconnected memory components is not lost. In one implementation, the data loss prevention technique is selected in a dynamic manner so which backup power structure is implemented, the storage controller may proactively react to prevent the data loss.

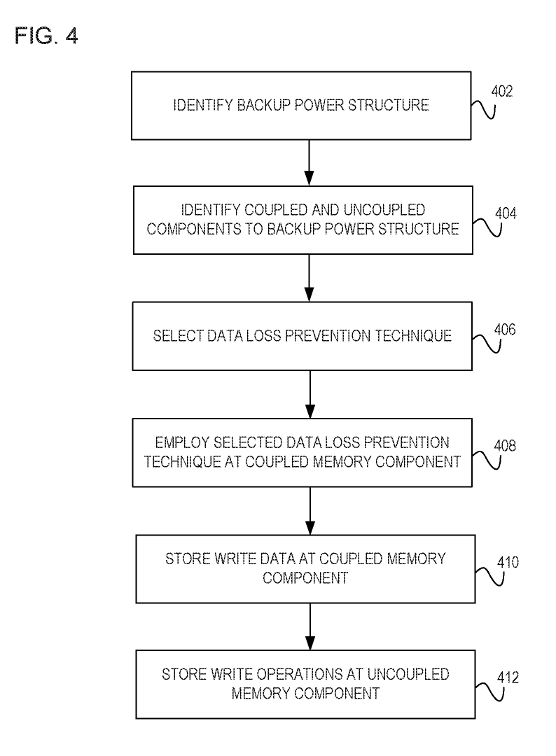

FIG. 4 is a flowchart of an example method, executed by a storage controller, to employ a selected data loss prevention technique. The selected data loss prevention technique storage write data at a memory component coupled to an identified backup power structure. The storage controller determines which backup power structure is implemented in a storage system and as such identifies which components are coupled and uncoupled to the backup power structure. Upon identifying the specific backup power structure, the storage controller selects the data loss prevention technique and employs the technique at one of the coupled components. Employing the data loss prevention technique at the coupled memory component, the storage controller may proceed to store write data at the coupled component. Based on identifying the memory components uncoupled to the backup power structure, the storage controller may proceed to store write operations at the uncoupled component. In discussing FIG. 4, references may be made to the components in FIGS. 1-2 to provide contextual examples. In one implementation, storage controller 106 as in FIG. 1 executes operations 402-412 to select the data loss prevention technique. Further, although FIG. 4 is described as implemented by the storage controller, it may be executed on other suitable components. For example, FIG. 4 may be implemented in the form of executable instructions on a machine-readable storage medium 604 and 704 as in FIGS. 6-7. In other implementations, the illustrated flowchart may be executed by a computing device.

At operation 402, the storage controller identifies which of the backup power structures is implemented in the storage system. In one implementation, determining which of the backup power structures is implemented includes determine which components are coupled to the backup power structure and which components are uncoupled. Operation 402 may be similar in functionality to operation 302 as in FIG. 3.

At operation 404, the storage controller identifies both coupled and uncoupled memory components. The coupled memory components may include those components which are connected to the identified backup power structure. As such, the coupled components are those components which may receive power from the backup power source in the event of a power outage of the storage system. The uncoupled memory components may include those components which may lose data in the event of power outage. As such, storage controller may want to exclude data retention on those uncoupled components. In another implementation, the storage controller accesses a list of which memory components are coupled to which backup power structure. Using this list, the storage controller may identify both the coupled and uncoupled memory components.

At operation 406 in response to the identified backup power structure, the storage controller selects the data loss prevention technique. The data loss prevention technique is selected among various data loss prevention techniques which each correspond to a different backup power structure. As such the selected data loss prevention technique depends on the type of the backup power structure implemented in the storage system. Operation 406 may be similar in functionality to operation 304 as in FIG. 3.

At operation 408, the storage controller employs the selected data loss prevention technique at the coupled memory component. As explained in connection with earlier figures, the data loss prevention technique is a set of actions in which the storage controller undertakes based on the identified backup power structure. For example, in response to the backup power source only supplying power to the coupled memory component, the storage controller may wait to move data from the memory component to persistent memory.

At operation 410, the storage controller writes data to the memory component that is coupled to the backup power structure. Identifying which memory components are coupled to the backup power source, ensures data at those components is not lost when power is removed. Thus, the storage controller identifies those coupled components to ensure user data and/or metadata is written.

At operation 412, the storage controller writes operations at the uncoupled memory component. In this implementation, the storage controller may write data concerning code execution and write operations at the uncoupled memory component. This data may be lost during the power outage.

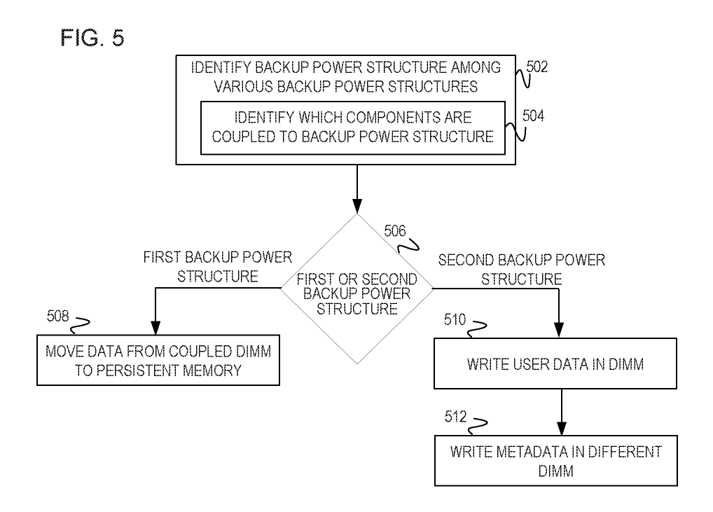

FIG. 5 is a flowchart of an example method, executable by a storage controller, to employ various selected data loss prevention techniques depending on a type of backup power structure that is implemented by a storage system. The storage controller identifies the specific backup power structure, among various backup power structures, implemented in the storage system. Based on the identification of the specific backup power structure, the storage controller may proceed to identify which components are coupled and which components are uncoupled to the identified backup power structure. In response to identifying whether the backup power structure is a first backup power storage or a second backup power structure, the storage controller may proceed to implement one of the various data loss prevention techniques. In discussing FIG. 5, references may be made to the components in FIGS. 1-2 to provide contextual examples. In one implementation, storage controller 106 as in FIG. 1 executes operations 402-412 to select the data loss prevention technique. Further, although FIG. 4 is described as implemented by the storage controller, it may be executed on other suitable components. For example, FIG. 4 may be implemented in the form of executable instructions on a machine-readable storage medium 604 and 704 as in FIGS. 6-7. In other implementations, the illustrated flowchart may be executed by a computing device.

At operation 502, the storage controller identifies the specific backup power structure that is implemented in the storage system. The backup power structures may include a first backup power structure and a second backup power structure, each backup power structure represents a different arrangement of coupled components. As such, the implemented data loss prevention technique may depend on which backup power structure is implemented as illustrated at operations 506-512. Operation 502 may be similar in functionality to operation 302 and operation 402 as FIGS. 3-4.

At operation 504, the storage controller identifies those components that are coupled to the implemented backup power structure and which are components are not coupled. Operation 504 may be similar in functionality to operation 404 as in FIG. 4.

At operation 506, the storage controller determines whether the identified backup power structure includes the first backup power structure or the second backup power structure. Each of the backup power structures represent a different arrangement or combination of components. For example, the first backup power structure may include delivering power to a DIMM, persistent memory, and storage controller. In response to the identified backup power structure including the first backup power structure, the storage controller may proceed to operation 508 for the selected data loss prevention technique. In response to the identified backup power structure including the second backup power structure, the storage controller may proceed to operations 510-512 to implement the data loss prevention technique.

At operation 508 in response to the backup power structure including the first backup power structure, the storage controller implements the data loss prevention technique of moving data from a DIMM to a persistent memory. In this implementation, when the storage system experiences a power outage, the first backup structure provides power to the storage controller to move data from the DIMM and places into the persistent memory. Upon moving the data from the DIMM to the persistent memory, the backup power source may power down.

At operations 510-512 in response to the backup power structure including the second backup power structure, the storage controller implements the data loss prevention technique of storing data in two different DIMMS. In this implementation, the storage controller identifies which DIMMs are connected to the backup power source and thus stores the user data in one DIMM and the metadata in the other coupled DIMM. In this implementation, when the storage system experiences the power outage, the second backup power structure provides power to at least two DIMMs. Thus, power can persist on those DIMMS for the period in which the second backup power source continues to provide power.

Referring now to FIGS. 6 and 7, machine-readable instructions are illustrated in accordance with various examples of the present disclosure. While illustrated in a particular order, the machine-readable instructions are not intended to be so limited. Rather, it is expressly contemplated that various machine-readable instructions may occur in different orders and/or simultaneously with other machine-readable instructions.

FIG. 6 is a block diagram of computing device 600 with a processing resource 602 to execute instructions 606-608 within a machine-readable storage medium 604. Specifically, the computing device 600 with the processing resource 602 is select a data loss prevention technique in response to a backup power structure that is implemented in a storage system. Upon selecting the data loss prevention technique, the processing resource 602 may proceed implement the data loss prevention technique. Although the computing device 600 includes processing resource 602 and machine-readable storage medium 604, it may also include other components that would be suitable. For example, the computing device 600 may include storage controller 106 as in FIG. 1. In other examples, the computing device 600 may include a controller, memory storage, or other suitable type of component. The computing device 600 is an electronic device with the processing resource 602 capable of executing instructions 606-608 and as such embodiments of the computing device 600 include a storage device, networking device, computing device, server, or other type of networking component capable of executing instructions 606-608. The instructions 606-608 may be implemented as methods, functions, operations, and other processes implemented as machine-readable instructions stored on the storage medium 604, which may be non-transitory, such as hardware storage devices (e.g., random access memory (RAM), read only memory (ROM), erasable programmable ROM, electrically erasable ROM, hard drives, and flash memory).

The processing resource 602 may fetch, decode, and execute instructions 606-608 to implement the selected data loss prevention technique. Specifically, the processing resource 602 executes instructions 606-608 to: select the data loss prevention technique in response to the identified backup power structure implemented in the storage system; and implement the selected data loss prevention technique at a memory component coupled to the backup power structure.

The machine-readable storage medium 604 includes instructions 606-608 for the processing resource 602 to fetch, decode, and execute. In another embodiment, the machine-readable storage medium 604 may be an electronic, magnetic, optical, memory, storage, flash-drive, or other physical device that contains or stores executable instructions. Thus, the machine-readable storage medium 604 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 504 may include an application and/or firmware which can be utilized independently and/or in conjunction with the processing resource 602 to fetch, decode, and/or execute instructions of the machine-readable storage medium 604. The application and/or firmware may be stored on the machine-readable storage medium 604 and/or stored on another location of the computing device 600.

FIG. 7 is a block diagram of computing device 700 with a processing resource 702 to execute instructions 706-724 within a machine-readable storage medium 704. Specifically, the computing device 700 with the processing resource 702 selects a data loss prevention technique in response to a backup power structure that is implemented in a storage system. Upon selecting the data loss prevention technique, the processing resource 702 may proceed implement the data loss prevention technique. Although the computing device 700 includes processing resource 702 and machine-readable storage medium 704, it may also include other components that would be suitable. For example, the computing device 700 may include storage controller 106 as in FIG. 1. In other examples, the computing device 700 may include a controller, memory storage, or other suitable type of component. The computing device 700 is an electronic device with the processing resource 702 capable of executing instructions 706-724 and as such embodiments of the computing device 700 include a storage device, networking device, computing device, server, or other type of networking component capable of executing instructions 706-724. The instructions 706-724 may be implemented as methods, functions, operations, and other processes implemented as machine-readable instructions stored on the storage medium 704, which may be non-transitory, such as hardware storage devices (e.g., random access memory (RAM), read only memory (ROM), erasable programmable ROM, electrically erasable ROM, hard drives, and flash memory).

The processing resource 702 may fetch, decode, and execute instructions 706-724 to implement the selected data loss prevention technique. Specifically, the processing resource 702 executes instructions 706-724 to: identify the specific backup power structure implemented in the storage system among various potential backup power structures; identify those components which are coupled to the identified backup power structure; based on the identified backup power structure, select the data loss prevent technique among various data loss prevention techniques each corresponding to a different backup power structure; implement the selected data loss prevention technique; in response to the identified backup power structure including a first backup power structure, implement the selected data loss prevention technique by storing user data in a DIMM coupled to the identified backup power structure and store metadata in a different DIMM also coupled to the identified backup power structure; and in response to the identified backup power structure including a second backup power structure, move data from the DIMM to a persistent memory, both the DIMM and persistent memory are coupled to the second backup power structure.

The machine-readable storage medium 704 includes instructions 706-724 for the processing resource 702 to fetch, decode, and execute. In another embodiment, the machine-readable storage medium 704 may be an electronic, magnetic, optical, memory, storage, flash-drive, or other physical device that contains or stores executable instructions. Thus, the machine-readable storage medium 704 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 704 may include an application and/or firmware which can be utilized independently and/or in conjunction with the processing resource 702 to fetch, decode, and/or execute instructions of the machine-readable storage medium 704. The application and/or firmware may be stored on the machine-readable storage medium 704 and/or stored on another location of the computing device 700.

Although certain implementations have been illustrated and described herein, it will be appreciated that a wide variety of alternate and/or equivalent implementations calculated to achieve the same purposes may be substituted for the implementations shown and described without departing from the scope of this disclosure. It may be appreciated that implementations may be implemented in a variety of ways. This application is intended to cover adaptions or variations of the implementations discussed herein. Therefore, it is manifestly intended that implementations be limited only by the claims and equivalents thereof.

We claim:

1. A method executable by a storage controller, the method comprising:
identifying a backup power structure among various backup power structures implemented in a storage system; and
in response to the identification of the backup power structure, selecting a data loss prevention technique, among various loss prevention techniques corresponding to the various backup power structures, to implement in storing write data to the storage system.

2. The method of claim 1 comprising:
identifying a memory component, among various memory components, coupled to the backup power structure; and
employing the selected data loss prevention technique at the identified memory component to store write data on the identified memory component.

3. The method of claim 2 comprising:
storing the write data at the identified memory component.

4. The method of claim 1 comprising:
implementing the selected data loss prevention technique on a dual in-line memory module (DIMM) coupled to the identified backup power structure.

5. The method of claim 1 comprising:
identifying a memory component not coupled to the backup power structure; and
storing write operations in the uncoupled memory component.

6. The method of claim 1 wherein the various backup power structures include a first backup power structure coupled to the storage controller and a second backup power structure not coupled to the storage controller.

7. The method claim 1 comprising:
based on implementation of the selected data loss prevent technique, storing user data in a dual in-line memory module (DIMM) coupled to the identified backup power structure; and
storing metadata in a different DIMM coupled to the identified backup power structure.

8. A storage system comprising:
a storage controller to:
identify backup power structure among various power structures that are implemented in the storage system; and
in response to the identification of the backup power structure, select data loss prevent technique among various data loss prevent techniques corresponding to the various power structures; and
a memory component, coupled to a backup power source, to:
receive power from the backup power source during a power outage of the storage system; and
store write data in accordance with the selected power technique.

9. The storage system of claim 8 wherein the various backup power structures include a first backup power structure coupled to the storage controller and a second backup power structure not coupled to the storage controller.

10. The storage system of claim 8 wherein to identify which backup power structure is implemented in the storage system, the storage controller is to:
identify which components in the storage system are coupled to the backup power structure; and
identify which components in the storage system are uncoupled to the backup power structure.

11. A non-transitory machine-readable storage medium comprising instructions that when executed by a processing resource cause a computing device to:
in response to an identification of a backup power structure, select a data loss prevention technique, among various loss prevention techniques corresponding to various backup power structures; and
implement the selected data loss prevention technique for storing write data to a storage system.

12. The non-transitory machine-readable storage medium of claim 11 comprising instructions that when executed by the processing resource cause the computing device to:
identify the backup power structure among the various backup power structures, wherein each of the various backup power structures provides power to a different combination of components in the storage system.

13. The non-transitory machine-readable storage medium of claim 12 wherein to implement the selected loss prevention technique for storing write data in the storage system comprises instructions that when executed by the processing resource cause the computing device to:
store user data at a dual in-line memory module (DIMM) coupled to the identified backup power structure; and
store metadata corresponding to the user data at a different DIMM coupled to the identified backup power structure.

14. The non-transitory machine-readable storage medium of claim 12 wherein to identify the backup power structure among the various power structures comprises instructions that when executed by the processing resource cause the computing device to:
identify a memory component powered by the identified backup power structure;
write data to the identified memory component; and
transfer the written data form the identified memory component to a persistent memory component.

15. The non-transitory machine-readable storage medium of claim 12 wherein to identify the backup power structure among the various backup power structures comprises instructions that when executed by the processing resource causes the computing device to:
identify a dual in-line memory module coupled to the identified backup power structure.
